(19) United States
(12) Patent Application Publication
(10) Pub. No.: US 2025/0202123 A1
(43) Pub. Date: Jun. 19, 2025

(54) ANTENNA MODULE AND ELECTRONIC DEVICE

(71) Applicant: Lenovo (Beijing) Limited, Beijing (CN)

(72) Inventors: Wenlei WANG, Beijing (CN); Dafei MO, Beijing (CN)

(21) Appl. No.: 18/983,167

(22) Filed: Dec. 16, 2024

(30) Foreign Application Priority Data
Dec. 19, 2023 (CN) 202311753367.6

(51) Int. Cl. H01Q 13/10

(52) U.S. Cl. CPC H01Q 13/10

(57) ABSTRACT

An antenna module includes a slot antenna structure and a metamaterial module. The slot antenna structure includes a feed point and a first substrate. The feed point is arranged at the first substrate. The metamaterial module is arranged at the first substrate. A position of the metamaterial module does not overlap with a position of the feed point. The metamaterial module is coupled with the feed point. The metamaterial module is configured to disperse an electromagnetic wave of the feed point.

### CROSS REFERENCE TO RELATED APPLICATION

The present disclosure claims priority to Chinese Patent Application No. 202311753367.6, filed on Dec. 19, 2023, the entire content of which is incorporated herein by reference.

### TECHNICAL FIELD

The present disclosure is related to the antenna technology field and, more particularly, to an antenna module and an electronic device.

### BACKGROUND

With the development of technology, users have higher requirements for the quality of the electronic products. An electronic product having a communication function is configured with an antenna structure. However, when some antenna structures radiate signals, the antenna structures have areas with relatively weak radiation strengths. The area with relatively weak radiation strength will affect the quality of the electronic product and the user experience.

### SUMMARY

An aspect of the present disclosure provides an antenna module, including a slot antenna structure and a metamaterial module. The slot antenna structure includes a feed point and a first substrate. The feed point is arranged at the first substrate. The metamaterial module is arranged at the first substrate. The position of the metamaterial module does not overlap with the position of the feed point. The metamaterial module is coupled with the feed point. The metamaterial module is configured to disperse an electromagnetic wave of the feed point.

An aspect of the present disclosure provides an electronic device including an antenna module. The antenna module includes a slot antenna structure and a metamaterial module. The slot antenna structure includes a feed point and a first substrate. The feed point is arranged at the first substrate. The metamaterial module is arranged at the first substrate. The position of the metamaterial module does not overlap with the position of the feed point. The metamaterial module is coupled with the feed point. The metamaterial module is configured to disperse an electromagnetic wave of the feed point.

### BRIEF DESCRIPTION OF THE DRAWINGS

FIG. 1 illustrates a schematic diagram showing antenna signal transmission according to some embodiments of the present disclosure.

FIG. 2 illustrates a schematic structural diagram of an antenna module in an unstably placed state according to some embodiments of the present disclosure.

FIG. 3 illustrates a schematic diagram showing signal transmission of an antenna module according to some embodiments of the present disclosure.

FIG. 4 illustrates a schematic structural diagram of an antenna module according to some embodiments of the present disclosure.

FIG. 5 illustrates a schematic structural diagram of another antenna module according to some embodiments of the present disclosure.

FIG. 6 illustrates a schematic structural diagram of another antenna module according to some embodiments of the present disclosure.

FIG. 7 illustrates a schematic structural diagram of another antenna module according to some embodiments of the present disclosure.

FIG. 8 illustrates a schematic structural diagram of another antenna module according to some embodiments of the present disclosure.

FIG. 9 illustrates a schematic structural diagram of another antenna module according to some embodiments of the present disclosure.

FIG. 10 illustrates a schematic structural diagram of another antenna module according to some embodiments of the present disclosure.

FIG. 11 illustrates a schematic structural diagram of an electronic device according to some embodiments of the present disclosure.

### DETAILED DESCRIPTION OF THE EMBODIMENTS

Embodiments of the present disclosure are described in detail below in connection with the accompanying drawings of embodiments of the present disclosure. Apparently, the described embodiments are merely some embodiments of the present disclosure, not all embodiments. Based on embodiments of the present disclosure, all other embodiments obtained by those skilled in the art without creative efforts are within the scope of the present disclosure.

To make the objectives, features, and advantages of the present disclosure clearer, the present disclosure is described further in detail in connection with the accompanying drawings and specific implementations.

Often, electronic products with communication functions can be provided with antenna structures. However, some antenna structures can have radiation dead zones, which affects the quality of the electronic products and user experience.

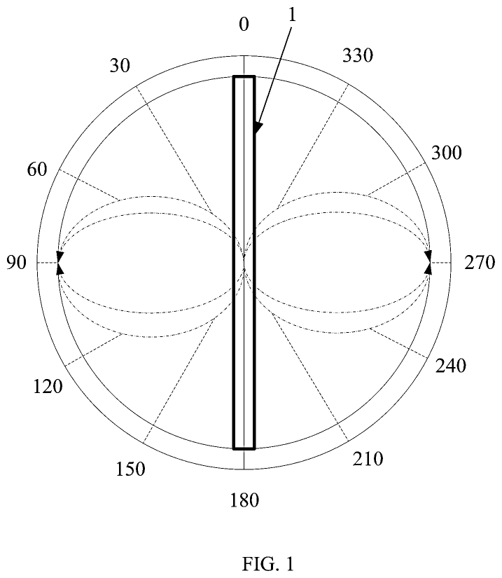

For example, a slot antenna, known for its low profile, integrability, and ease of array formation, attracts extensive attention and has become a mainstream trend in the antenna structure of electronic products. However, during the application, the slot antenna includes the following problems. As shown in FIG. 1, 1 represents a slot of the slot antenna. The slot antenna is usually made of a conductor. The slot can be a part of the antenna element. Since the slot introduces a function of an opening resonator into an electromagnetic field, the vertical electromagnetic wave can form a resonance in the slot to enhance the radiation effect. On the other hand, the electromagnetic wave parallel to the slot direction can have a relatively weak resonance effect. Thus, the radiation can be relatively weak. With such a structure feature, the signal perpendicular to the slot direction can have relatively high radiation strength, while the signal radiation can be weak parallel to the slot direction.

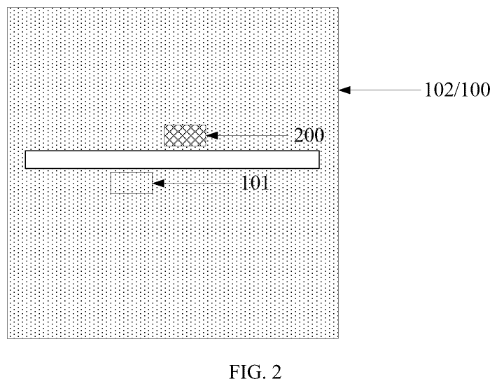

Based on this, the present disclosure provides an antenna module. FIG. 2 illustrates a schematic structural diagram of an antenna module in an unstably placed state according to some embodiments of the present disclosure. The antenna module includes a slot antenna structure 100 and a metamaterial module 200.

The slot antenna structure 100 includes a feed point 101 and a first substrate 102. The feed point 101 is arranged at the first substrate 102 and is configured to radiate an electromagnetic wave.

The metamaterial module 200 is arranged at the first substrate 102. The position of the metamaterial module 200 does not overlap with the position of the feed point 101. That is, the metamaterial module 200 and the feed point 101 are spaced apart and arranged separately.

The metamaterial module 200 is coupled with the feed point 101 and configured to disperse the electromagnetic wave from the feed point 101. The metamaterial module 200 coupling with the feed point 101 can mean that the electromagnetic wave can be transmitted between the metamaterial module 200 and the feed point 101.

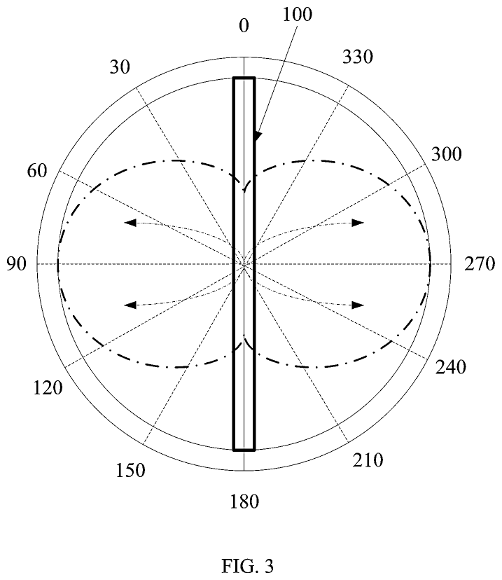

Based on this, the antenna module of the present disclosure includes the slot antenna structure 100 and the metamaterial module 200, and the metamaterial module 200 is coupled to the feed point 101 of the slot antenna structure 100 to disperse the electromagnetic wave radiated by the feed point 101. Hence, the antenna module includes the slot antenna structure 100 and the metamaterial module 200 arranged separately from the feed point 101 of the slot antenna structure 100. The metamaterial module 200 can disperse the electromagnetic wave of the feed point 101. Then, the antenna module can cause the electromagnetic wave radiated by the feed point 101 to reach the metamaterial module 200 through space and then be dispersed by the metamaterial module 200 to further allow the electromagnetic wave radiated by the feed point 101 in different directions. FIG. 3 illustrates a radiation diagram, which shows that the radiation dead zone problem is effectively solved, and the radiation performance of the antenna module is improved.

The metamaterial module 200 can be configured to disperse the electromagnetic wave of the feed point 101. For example, the metamaterial module 200 can be a composite material having a special micro-structure. By designing and arranging the micro-units, the electromagnetic wave can be controlled and adjusted. In the present disclosure, the micro-structure and the composition type are not limited, as long as the metamaterial module 200 can disperse the electromagnetic wave.

The metamaterial module 200 can be arranged at the first substrate 102 through gluing, welding, threaded connection, and snap connection, which are not limited to the present disclosure. Those skilled in the art can choose a suitable arrangement as needed.

By additionally arranging the metamaterial module 200 having the electromagnetic dispersion function at the first substrate 102, the electromagnetic wave can be dispersed, and the structure and size of the antenna module may not need to be changed. Thus, the antenna module can also be easily prepared.

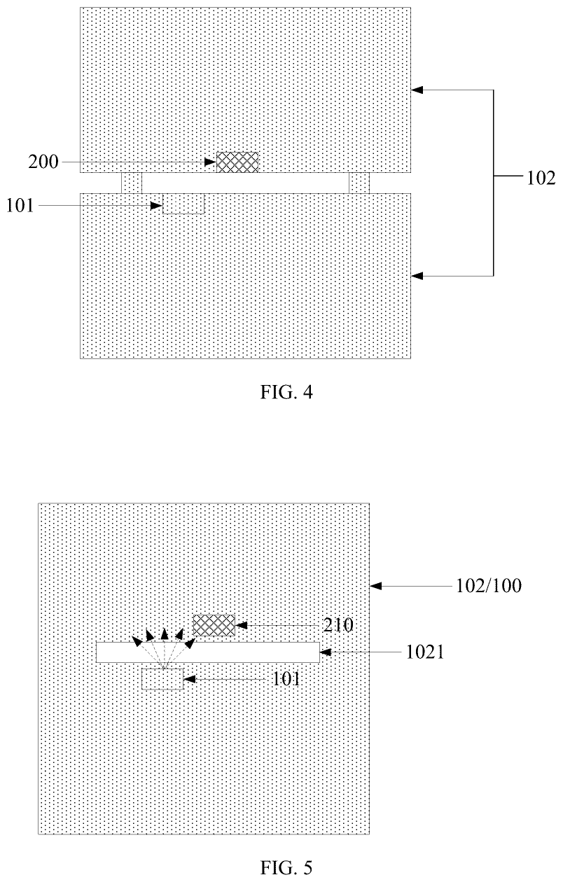

For the first substrate 102, in embodiments of the present disclosure, as shown in FIG. 2, the first substrate 102 can be an integral structure. In some other embodiments of the present disclosure, FIG. 4 illustrates a schematic structural diagram of an antenna module according to some embodiments of the present disclosure. The first substrate 102 is a substrate structure made of a plurality of structures. Based on the above, in the present disclosure, the structural form and shape of the first substrate 102 are not limited. Thus, the antenna module can be suitable for more application scenarios and have stronger practical applications. In the antenna module of FIG. 4, the first substrate 102 is formed by combining two structures. However, FIG. 4 illustrates the structure of the antenna module and does not limit the structure of the antenna module. In other embodiments of the present disclosure, the first substrate 102 can be formed by combining three structures, four structures, or more, which is not limited to the present disclosure depending on the situation.

Based on the above, the first substrate 102 can be an integral structure or a substrate structure formed by combining a plurality of structures. For the metamaterial module 200, in some embodiments of the present disclosure, FIG. 5 illustrates a schematic structural diagram of another antenna module according to some embodiments of the present disclosure. The first substrate 102 includes a slot 1021. The metamaterial module 200 includes a metamaterial unit 210 having a negative refraction feature. The metamaterial unit 210 is arranged at the edge of the slot 1021.

In some embodiments, the metamaterial module 200 can include the metamaterial unit 210 having the negative refraction feature. Then, when the electromagnetic wave radiated by the feed point 101 is transmitted to the metamaterial unit 210, the electromagnetic wave reflected by the metamaterial unit 210 and the electromagnetic wave refracted by the metamaterial unit 210 can be in a same incident surface to generate a dispersion effect. Thus, the metamaterial unit 210 can disperse the electromagnetic wave radiated by the feed point 101. Then, the electromagnetic wave radiated by the feed point 101 can radiate to various directions. The electromagnetic wave parallel to the slot 1021 can be enhanced, and the radiation dead zone problem of the slot antenna structure 100 can be effectively solved. Further, the radiation performance of the antenna module can be improved. The direction parallel to the slot 1021 can be a direction parallel to the plane where the slot is formed.

Based on the above, in some embodiments of the present disclosure, as shown in FIG. 5, at least a portion of the coupling path between the metamaterial unit 210 and the feed point 101 passes through the slot 1021. That is, a part of or all electromagnetic waves transmitted between the metamaterial unit 210 and the feed point 101 can pass through the slot 1021. That is, the part of or all the electromagnetic waves radiated by the feed point 101 can pass through the slot 1021 to the metamaterial unit 210 and then be dispersed by the metamaterial unit 210. Since the part of or all of the electromagnetic waves radiated by the feed point 101 pass through the slot 1021 and are transmitted to the metamaterial unit 210, i.e., the slot 1021 is on the coupling path between the feed point 101 and the metamaterial unit 210, at least a part of the electromagnetic wave dispersed by the metamaterial unit 210 can also pass through the slot 1021 to enhance the electromagnetic wave radiated from the slot 1021. Thus, the electromagnetic wave radiated in the direction in parallel to the slot 1021 can be enhanced, and the radiation dead zone problem of the slot antenna structure 100 can be effectively solved.

Additionally, the part or all of the electromagnetic waves radiated by the feed point 101 can be transmitted through the slot 1021 to the metamaterial unit 210. The medium for transmitting the electromagnetic waves radiated from the feed point 101 to the metamaterial unit 210 can be air. Thus, the impedance of the coupling path between the feed point 101 and the metamaterial unit 210 can be relatively small, which reduces the loss of the electromagnetic waves in the transmission and is beneficial to improve the radiation performance of the antenna module. Meanwhile, the part or all of the electromagnetic waves radiated by the feed point 101 can be transmitted to the metamaterial unit 210 through the slot 1021. Thus, the impedance of the coupling path between the feed point 101 and the metamaterial unit 210 can be relatively small, and the coupling capability between the feed point 101 and the metamaterial unit 200 can be enhanced. Thus, more electromagnetic waves radiated by the feed point 101 can be received by the metamaterial unit and dispersed to improve the radiation performance of the antenna module.

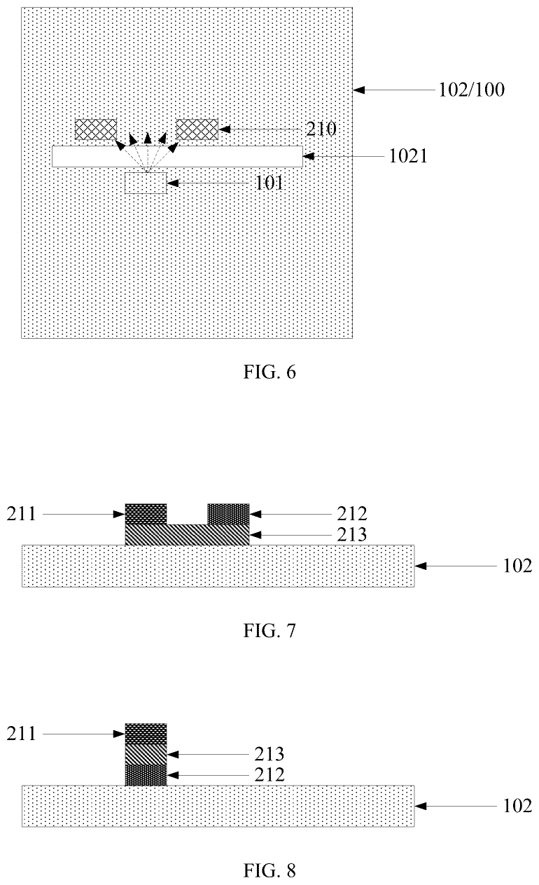

FIG. 6 illustrates a schematic structural diagram of another antenna module according to some embodiments of the present disclosure. The metamaterial module 200 includes a plurality of metamaterial units 210. The plurality of metamaterial units 210 are arranged apart at the edge of the slot 1021 to enhance the electromagnetic wave radiated in parallel to the slot direction to solve the radiation dead zone problem for the slot antenna structure 100.

The metamaterial unit 210 has a negative refraction feature. Thus, the electromagnetic wave reflected by the metamaterial unit 210 and the electromagnetic wave refracted by the metamaterial unit 210 can be in the same incident surface to disperse the electromagnetic wave radiated by the feed point 101. However, the electromagnetic wave radiated by the feed point 101 can be transmitted to the metamaterial unit 210 from any direction. Thus, to cause the metamaterial unit 210 to have a better dispersion effect for the electromagnetic waves when the plurality of metamaterial units 210 are provided, the plurality of metamaterial units 210 can be arranged apart to avoid shielding among the plurality of metamaterial units 210. Then, the dispersion effect of the metamaterial units 210 for the electromagnetic waves can be improved, which is beneficial to enhance the electromagnetic waves radiated in the direction in parallel to the direction of the slot 1021. Thus, the radiation dead zone problem of the slot antenna 100 can be solved.

Based on the above, in embodiments of the present disclosure, the metamaterial unit 210 includes at least one of an opening resonance unit 211 and a subwavelength structure 212. That is, the above metamaterial unit can include the opening resonance unit 211, the subwavelength structure 212, or the opening resonance unit 211 and the subwavelength structure 212. Thus, the metamaterial unit 210 can have the negative refraction feature to disperse the electromagnetic wave radiated by the feed point 101.

Based on the above, in embodiments of the present disclosure, the above opening resonance unit 211 can be an opening resonator formed by arranging at least one opening resonance ring apart. The opening resonance ring can include at least one opening. When the opening resonance ring includes a plurality of openings, the plurality of openings can be arranged symmetrically or asymmetrically. In addition, if the opening resonance unit 211 is an opening resonator formed by the plurality of opening resonance rings. A number of openings of the plurality of opening resonance rings can be same or different. In embodiments of the present disclosure, the subwavelength structure 212 can be made of at least one metal short wire arranged apart, which is not limited in the present disclosure. In other embodiments of the present disclosure, the opening resonance unit and the subwavelength structure can be other elements having negative refraction features, which depend on the situation.

Based on the above, in embodiments of the present disclosure, the metamaterial unit 210 can include the opening resonance unit 211 and the subwavelength structure 212.

Based on the above, FIG. 7 illustrates a schematic structural diagram of another antenna module according to some embodiments of the present disclosure. The metamaterial unit 210 includes the opening resonance unit 211, the subwavelength structure 212, and the second substrate 213. The opening resonance unit 211 and the subwavelength structure 212 can be arranged at the first substrate 213 through the second substrate 102.

The opening resonance unit 211 and the subwavelength structure 212 can be arranged at the first surface of the second substrate 213. That is, the opening resonance unit 211 can be arranged at the first surface of the second substrate 213. The subwavelength structure 212 can also be arranged at the first surface of the second substrate 213, and the opening resonance unit 211 and the subwavelength structure 212 can be arranged at the first substrate 102 through the second substrate 213. That is, the opening resonance unit 211 and the subwavelength can be arranged on the same side of the second substrate 213 and at the first substrate 102 through the second substrate 213. If the opening resonance unit 211 and the subwavelength structure 212 are arranged on the same side of the second substrate 213, in embodiments of the present disclosure, the opening resonance unit 211 and the subwavelength structure 212 can be arranged at intervals. The opening resonance unit 211 and the subwavelength structure 212 can be arranged in sequence along the extension direction of the slot 1021.

In some other embodiments, FIG. 8 illustrates a schematic structural diagram of another antenna module according to some embodiments of the present disclosure. The opening resonance unit 211 is arranged at the first surface of the second substrate 213. The subwavelength structure 212 is arranged at the second surface of the second substrate 213. The opening resonance unit 211 and the subwavelength structure 212 are arranged at the first substrate 102 through the second substrate 213. The second surface of the second substrate 213 can be a side surface away from the first surface. The second substrate 213 can be parallel to the first substrate 102. In some embodiments, the first surface of the second substrate 213 can be a side surface facing the first substrate 102, and the second surface can be the side surface away from the first substrate 102. That is, the opening resonance unit 211 and the subwavelength structure 212 can be arranged on two surfaces of the second substrate 213 opposite to each other and can be arranged at the first substrate 102 through the second substrate 213. If the opening resonance unit 211 and the subwavelength structure 212 are located at the two surfaces of the second substrate 213 opposite to each other, the opening resonance unit 211 can face the subwavelength structure 212 or can at least have a partial non-overlapping area, which is not limited in the present disclosure and depends on the situations.

Based on the above, when the metamaterial unit 212 includes the opening resonance unit 211 and the subwavelength structure 212, the opening resonance unit 211 and the subwavelength structure 212 can be arranged side by side at the first substrate 102 through the second substrate 213 or can be stacked at the first substrate 102 through the second substrate 213, which is not limited in the present disclosure. Those skilled in the art can choose a suitable arrangement method according to the actual needs. Thus, the antenna module can be applied to more application scenarios.

When the opening resonance unit 211 and the subwavelength structure 212 are stacked at the first substrate 102, the opening resonance unit 211 can face the first substrate 102, and the subwavelength structure 212 can face the first substrate 102, which is not limited to the present disclosure and depends on the situation. In addition, when the metamaterial unit 210 only includes the opening resonance unit 211 or only the subwavelength structure 212, the metamaterial unit 210 can also be arranged at the first substrate 102 through the second substrate 213. The first substrate 102 and the second substrate 213 can be structures having conductivity and used as substrates, e.g., circuit board, metal structure, or ceramic structure, which is not limited in the present disclosure. Those skilled in the art can choose a suitable arrangement method as needed.

In some embodiments, if the opening resonance unit 211 and the subwavelength structure 212 are arranged on a same side of the second substrate 213, the opening resonance unit 211 and the subwavelength structure can be arranged at the second substrate 213 through gluing, welding, threaded connection, snap connection, etc. The second substrate 213 can be glued, welded, threadedly connected, or snapped at the first substrate 102, which is not limited in the present disclosure. Those skilled in the art can choose the suitable arrangement methods as needed.

In some embodiments, if the opening resonance unit 211 and the subwavelength structure 212 are arranged at two surfaces of the second substrate 213 facing away from each other, the opening resonance unit 211 and the subwavelength structure 212 can be arranged at the two surfaces of the second substrate 213 away from each other through gluing, welding, threaded connection, or snap connection. Based on the above, in some embodiments, if the opening resonance unit 211 faces the first substrate 102, the opening resonance unit 211 can be glued at the first substrate 102. In some embodiments, if the subwavelength structure 212 faces the first substrate 102, the subwavelength structure 212 can be glued, welded, threadedly connected, or snapped at the first substrate 102, which is not limited in the present disclosure. Those skilled in the art can choose a suitable method as needed.

For the slot antenna, the feed point can be directly arranged at the first substrate 102 or at the carrier through the antenna. Thus, the slot antenna structure 100 can further include a sub-antenna. The sub-antenna can be arranged at the edge of the slot 1021 of the first substrate 102. Based on the above, in some embodiments, the feed point 101 can be arranged at the sub-antenna. In some other embodiments, the sub-antenna can form the feed point 101. That is, the feed point 101 can be directly arranged at the first substrate 102.

Based on the above, in some embodiments, to cause more electromagnetic waves radiated by the feed point 101 to be received and dispersed by the metamaterial module 200, as shown in FIG. 6, the plurality of metamaterial modules 200 are provided. At least one metamaterial module 200 can be arranged at each of the two sides of the feed point 101 opposite to each other. That is, each feed point 101 can at least correspond to two metamaterial modules 200. The two metamaterial modules 200 can be arranged on two sides of the feed point 101 opposite to each other, respectively.

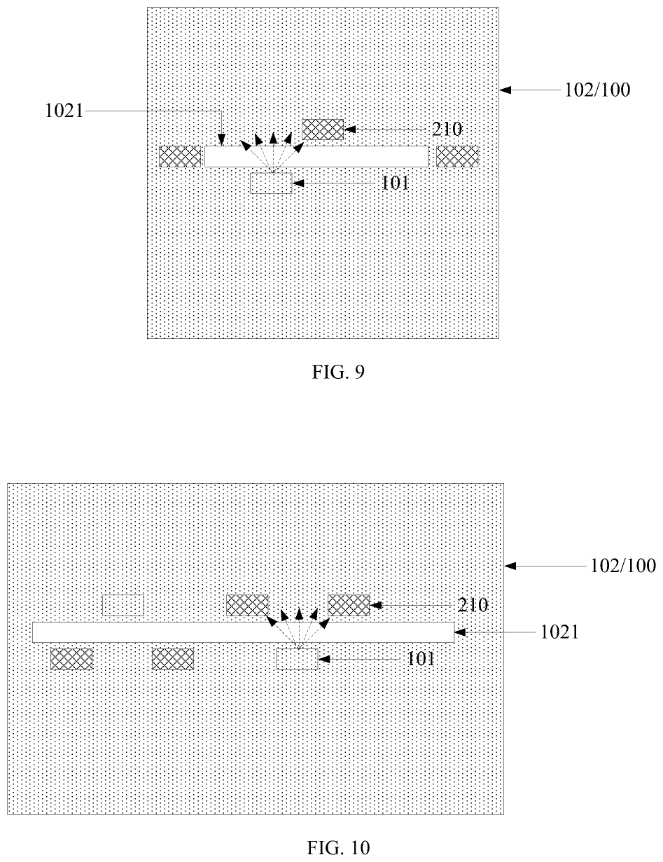

In some embodiments, FIG. 9 illustrates a schematic structural diagram of another antenna module according to some embodiments of the present disclosure. When the plurality of metamaterial modules 200 are provided, in addition to the metamaterial modules 200 on the two opposite sides of the feed point 101, at least one metamaterial module 200 can be arranged at each of the two ends of the slot 1021 to further ensure the electromagnetic waves radiated in the direction parallel to the direction of the slot 1021 to improve the radiation dead zone problem. If the slot 1021 is a rectangular structure, the at least one metamaterial module 200 arranged at each of the two ends of the slot 1021 can indicate that at least one metamaterial module 200 can be arranged at each of two side areas close to the short side of the slot 1021, and the first side and the second side of the slot 1021 are two opposite long sides of the slot 1021.

In addition, in some embodiments, to cause more electromagnetic waves radiated by the feed point 101 to be transmitted to and better dispersed by the metamaterial module 200, the slot 1021 can include the first side and the second side opposite to each other, the feed point 101 can be arranged on the first side, and the metamaterial module 200 can be arranged on the second side. Thus, the metamaterial module 200 and the feed point 101 can be arranged on opposite sides. Then, more electromagnetic waves radiated by the feed point 101 can be transmitted to and dispersed by the metamaterial module 200 to ensure the dispersion effect and better solve the radiation dead zone problem.

The above is intended to describe that the metamaterial module 200 and the feed point 101 are arranged on two opposite sides. Not all feed points 101 are arranged on the first side, and not all metamaterial modules 200 are arranged on the second side. FIG. 10 illustrates a schematic structural diagram of another antenna module according to some embodiments of the present disclosure. The feed point 101 can be arranged on the first side or the second side. Each feed point 101 can have a corresponding metamaterial module 200 arranged on the opposite side.

To better use the negative refraction feature of the metamaterial module 200, the feed point 101 and the corresponding metamaterial module 200 can satisfy a certain distance requirement. Thus, in embodiments of the present disclosure, the distance between the metamaterial module 200 and the feed point 101 may not be smaller than ¼λ. That is, the distance between the metamaterial module 200 and the feed point 101 can be greater than or equal to ¼λ, and λ is the wavelength of the electromagnetic wave. When the feed point 101 and the metamaterial module 200 are arranged on the opposite sides, the distance between the feed point 101 and the metamaterial module 200 can be in the extension direction of the slot 1021. The distance between the metamaterial module 200 and the feed point 101 can be not smaller than ¼λ.

The present disclosure further provides an electronic device. The electronic device includes any one of the antenna modules above.

In embodiments of the present disclosure, the electronic device can be a laptop, mobile terminal, or any device that can receive a signal through the antenna module. That is, the type of the electronic device can be determined as needed and is not limited to the present disclosure.

The electronic device can include the slot antenna structure 100 and the metamaterial module 200 arranged separately from the feed point 101 of the slot antenna structure 100. The metamaterial module 200 can be configured to disperse the electromagnetic waves of the feed point 101. Thus, the electromagnetic waves radiated by the feed point 101 of the antenna module of the electronic device can be radiated in various directions to effectively solve the radiation deed zone problem of the slot antenna structure 100. Thus, the radiation performance of the antenna module can be improved to cause the electronic device to have better antenna radiation performance, and the user experience can be improved.

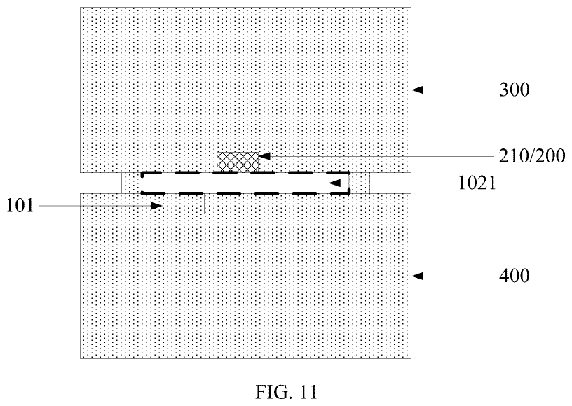

In some embodiments, FIG. 11 illustrates a schematic structural diagram of an electronic device according to some embodiments of the present disclosure. The electronic device includes a first body 300 and a second body 400 that are rotatable relative to each other. The slot 1021 of the slot antenna structure 100 is formed between the first body 300 and the second body 400. That is, the first body 300 and the second body 400 of the electronic device can be a part of the slot antenna structure 100, which simplifies the process of arranging the antenna module in the electronic device to further simplify the preparation process of the electronic device.

Since the first body 300 and the second body 400 of the electronic device form the slot of the slot antenna structure, a slot may not need to be additionally opened on the housing of the electronic device to arrange the slot antenna structure, and the slot can be avoided at the housing of the electronic device. Especially for the electronic device with metal housing, the slot can be avoided at the housing of the electronic device to affect the aesthetic appearance of the electronic device.

The first body 300 and the second body 400 can form the slot 1021 of the slot antenna structure 100. In some embodiments, the first body 300 and the second body 400 can form the first substrate 102. At least a portion of the edge of the first body 300 and the at least a portion of the edge of the second body 400 form the edge of the slot 1021 of the slot antenna structure 100.

In some embodiments, as shown in FIG. 11, the feed point 101 is arranged at the first body 300, and the metamaterial module 200 is arranged at the second body 400. In some other embodiments of the present disclosure, the feed point 101 can be located at the second body 400, and the metamaterial module 200 can be arranged at the first body 300. Thus, in the electronic device of the present disclosure, the arrangement of the feed point 101 and the metamaterial module 200 are not limited, can be applied to more application scenarios, and can be more practical.

In some other embodiments, the feed point 101 and the metamaterial module 200 can be simultaneously arranged at the first body 300 or at the second body 400, which is not limited in the present disclosure. To ensure the dispersion effect of the metamaterial module 200 to the electromagnetic waves of the feed point 101, the feed point 101 and the metamaterial module 200 can be arranged on opposite sides.

In some embodiments, the first body 300 and the second body 400 can move relatively. For example, the first body 300 and the second body 400 can be rotatably connected through a rotation assembly. The rotation assembly can include two rotation assemblies arranged separately. Thus, at least a portion of the edge of the first body 300, at least a portion of the edge of the second body 400, and at least a portion of the edge of the rotation assemblies can form the slot 1021 of the slot antenna structure 100. The metamaterial modules 200 arranged at the two ends of the slot 1021, respectively, can mean that the metamaterial modules 200 can be arranged at the two rotation assemblies, respectively.

In some embodiments of the present disclosure, the electronic device can be a laptop. The first body 300 can include a screen, and the second body 400 can include a keyboard, which is not limited in the present disclosure. The electronic device can be an electronic product other than the laptop, which is determined according to the situation.

In summary, the present disclosure provides the antenna module and the electronic device. The antenna module can include the slot antenna structure and the metamaterial module. The slot antenna structure can include the feed point and the first substrate. The feed point and the metamaterial module can be arranged at the first substrate, and the position of the metamaterial module may not overlap with the position of the feed point. The metamaterial module can be coupled with the feed point to disperse the electromagnetic waves of the feed point. Thus, the antenna module can cause the electromagnetic waves radiated by the feed point to reach the metamaterial module through the space and then be dispersed by the metamaterial module. Thus, the electromagnetic waves radiated by the feed point can be radiated in various directions to effectively solve the radiation dead zone problem of the slot antenna structure to further improve the radiation performance of the antenna module.

Embodiments of the present disclosure are described in a progressive manner, a parallel manner, or a combination of progressive and parallel manners. Each embodiment focuses on the difference from other embodiments. Similar or same areas among embodiments of the present disclosure can refer to each other. For the apparatus of embodiments of the present disclosure, since the apparatus corresponds to the method of embodiments of the present disclosure, the related description can be simple. For the relative parts, reference can be made to the description of the method embodiments.

In the present disclosure, orientation or positional relationships indicated by terms “upper,” “lower,” “top,” “bottom,” “inner,” “outer,” etc., are based on the orientations or position relationships shown in the accompanying drawings. The terms are merely used to describe the present disclosure and simplify the description instead of indicating or implying that the apparatus or elements must have a certain orientation or must be constructed or operated in a certain orientation, and should not be considered as limiting the present disclosure. When an assembly is considered as being connected to another assembly, the assembly can be directly connected to another assembly or an intermediate assembly can be arranged therebetween.

Additionally, relational terms such as “first” and “second” are only used to distinguish one entity or operation from another entity or operation and do not necessarily indicate any specific relationship or order between the entities or operations. Moreover, terms such as “comprising,” “including,” or any of their variations, are intended to encompass non-exclusive inclusions, such that an item or device that includes a series of elements not only includes those elements but can also include additional elements not explicitly listed, or elements that are inherent to the item or device. Without further limitations, an element defined by the phrase “comprising a . . . ” does not exclude the presence of additional and identical elements in the item or device.

The above description of embodiments of the present disclosure enables those skilled in the art to implement or use the present disclosure. Various modifications to these embodiments are apparent to those skilled in the art. The general principles defined in the specification can be applied to other embodiments without departing from the spirit or scope of the present disclosure. Therefore, the present disclosure is not limited to embodiments of the present disclosure but should conform to the broadest scope consistent with the principles and novel features of the present disclosure.

What is claimed is:

1. An antenna module comprising:
a slot antenna structure including a feed point and a first substrate, the feed point being arranged at the first substrate; and
a metamaterial module arranged at the first substrate, a position of the metamaterial module not overlapping with a position of the feed point;
wherein:
the metamaterial module is coupled with the feed point; and
the metamaterial module is configured to disperse an electromagnetic wave of the feed point.

2. The antenna module according to claim 1, wherein:
the first substrate has an integral structure or is formed by a plurality of structures; and
the first substrate includes a slot, the metamaterial module includes a metamaterial unit having a negative refraction feature, and the metamaterial unit is arranged at an edge of the slot.

3. The antenna module according to claim 2, wherein at least a portion of a coupling path of the metamaterial unit and the feed point passes through the slot.

4. The antenna module according to claim 2, wherein:
the metamaterial module includes a plurality of metamaterial units arranged at the edge of the slot at an interval; and/or
one metamaterial unit of the plurality of metamaterial units includes at least one of an opening resonance unit and a subwavelength structure.

5. The antenna module according to claim 4, wherein:
the metamaterial unit includes the opening resonance unit, the subwavelength structure, and a second substrate, the opening resonance unit and the subwavelength structure being arranged at the first substrate through the second substrate;
the opening resonance unit and the subwavelength structure are arranged at a first surface of the second substrate; or
the opening resonance unit is arranged at the first surface of the second substrate, the subwavelength structure is arranged at a second surface of the second substrate, and the second surface of the second substrate is opposite the first surface.

6. The antenna module according to claim 2, wherein the slot antenna structure includes a sub-antenna arranged at the edge of the slot of the first substrate, the feed point being arranged at the sub-antenna, or the sub-antenna forming the feed point.

7. The antenna module according to claim 1, wherein a plurality of metamaterial modules are provided, and at least one metamaterial module is arranged at each side of two opposite sides of the feed point.

8. The antenna module according to claim 2, wherein:
the slot includes a first side and a second side opposite to each other, the feed point is arranged on the first side, and the metamaterial module is arranged on the second side; and/or
a distance between the metamaterial module and the feed point is not smaller than ¼λ, and 2 is a wavelength of the electromagnetic wave of the feed point.

9. An electronic device comprising an antenna module including:
a slot antenna structure including a feed point and a first substrate, the feed point being arranged at the first substrate; and
a metamaterial module arranged at the first substrate, a position of the metamaterial module not overlapping with a position of the feed point;
wherein:
the metamaterial module is coupled with the feed point; and
the metamaterial module is configured to disperse an electromagnetic wave of the feed point.

10. The electronic device according to claim 9, further comprising a first body and a second body, wherein:
a slot of the slot antenna structure is formed between the first body and the second body; and/or
the feed point is arranged at the first body of the electronic device, and the metamaterial module is arranged at the second body of the electronic device.

11. The electronic device according to claim 9, wherein:
the first substrate has an integral structure or is formed by a plurality of structures; and
the first substrate includes a slot, the metamaterial module includes a metamaterial unit having a negative refraction feature, and the metamaterial unit is arranged at an edge of the slot.

12. The electronic device according to claim 11, wherein at least a portion of a coupling path of the metamaterial unit and the feed point passes through the slot.

13. The electronic device according to claim 11, wherein:
the metamaterial module includes a plurality of metamaterial units arranged at the edge of the slot at an interval; and/or
one metamaterial unit of the plurality of metamaterial units includes at least one of an opening resonance unit and a subwavelength structure.

14. The electronic device according to claim 13, wherein:
the metamaterial unit includes the opening resonance unit, the subwavelength structure, and a second substrate, the opening resonance unit and the subwavelength structure being arranged at the first substrate through the second substrate;
the opening resonance unit and the subwavelength structure are arranged at a first surface of the second substrate; or
the opening resonance unit is arranged at the first surface of the second substrate, the subwavelength structure is arranged at a second surface of the second substrate, and the second surface of the second substrate is opposite the first surface.

15. The electronic device according to claim 11, wherein the slot antenna structure includes a sub-antenna arranged at the edge of the slot of the first substrate, the feed point being arranged at the sub-antenna, or the sub-antenna forming the feed point.

16. The electronic device according to claim 9, wherein a plurality of metamaterial modules are provided, and at least one metamaterial module is arranged at each side of two opposite sides of the feed point.

17. The electronic device according to claim 11, wherein:
the slot includes a first side and a second side opposite to each other, the feed point is arranged on the first side, and the metamaterial module is arranged on the second side; and/or
a distance between the metamaterial module and the feed point is not smaller than ¼λ, and 2 is a wavelength of the electromagnetic wave of the feed point.
